(19) United States
(12) Patent Application Publication
(10) Pub. No.: US 2010/0090519 A1
(43) Pub. Date: Apr. 15, 2010

(54) Composite material wheel rim structure

(75) Inventor: Shih Hung Lin, Tainan County (TW)

Correspondence Address: BACON & THOMAS, PLLC, 625 SLATERS LANE, FOURTH FLOOR, ALEXANDRIA, VA, 22314-1176, US

(73) Assignee: Taiwan Hodaka Industrial Co., Ltd., Tainan County (TW)

(21) Appl. No.: 12/588,378

(22) Filed: Oct. 14, 2009

(30) Foreign Application Priority Data
Oct. 14, 2008 (TW) 097218351

(51) Int. Cl. B60B 21/06

(52) U.S. Cl. 301/58

(57) ABSTRACT

A composite material wheel rim structure is disclosed, where an inner rim surface of the composite material wheel rim is linked by an attachment cap of each spoke, and a rigid inner lining chunk is enwrapped by the inner rim surface during the shaping of the composite material wheel rim, which enables the drilling of threaded holes at the inner lining chunk. And the inner lining chunk is used for the sustaining of the destruction due to the drilling for the threaded holes and of the strain due to the link of the attachment caps of the spokes, which enables a handy drilling for the threaded holes at the inner rim surface of the composite material wheel rim. And the adjustment of the tightness of a spoke is subject to the adjustment of the depth that the attachment cap joined helically to that threaded hole.

### BACKGROUND OF THE INVENTION

1. Field of the Invention

This invention relates generally to a composite material wheel rim structure and more specifically to one, where an inner rim surface of the composite material wheel rim is connected by each spoke, and the spot for the connection is capable of sustaining the destruction by the drilling of a threaded hole, which is for helical joining to an attachment cap of the spoke and for the adjustment of the tightness of the spoke.

2. Description of the Prior Art

As for bike wheel rim, its outer rim surface joins the tire, and its inner rim surface links up the wheel hub in the center of the wheel rim through a radial arrangement of spokes. The spoke is capable of being adjusted for its tightness. And the connection between the spoke and the inner rim surface of the wheel rim is carried out by joining an attachment cap helically to a threaded hole, where the attachment cap is provided with threads on its external side and is located at one end of a spoke, while the threaded hole is located at a corresponding location at the inner rim surface of the wheel rim. By adjusting the depth that the attachment cap is joined helically to the threaded hole, the tightness of a spoke will follow suit. Composite materials feature lightweight and tenacity in nature, which is also the preferred selection of substance for the bike frame. However, once the composite material is used to produce the wheel rim, it would suffer the drawbacks of insufficient stress for sustaining the drilling of threaded holes at the inner rim surface of the composite material wheel rim, where the threaded hole is for the accommodation of the attachment cap of a spoke. And cracks are easily created at the spot around the drilling at the inner rim surface of the composite material wheel rim.

### SUMMARY OF THE INVENTION

In the light of the aforementioned drawbacks of the prior art, this inventor conceived the idea for the advanced improvement, and eventually the endeavors gave birth to this invention.

The objective of this invention is therefore to provide a composite material wheel rim structure, where the composite material wheel rim is connected by each spoke, and the spot for the connection is capable of sustaining the destruction by the drilling of a threaded hole.

This invention features: the inner rim surface of the composite material wheel rim is linked by the attachment cap of each spoke, and a rigid inner lining chunk is being enwrapped by the inner rim surface during the shaping of the composite material wheel rim, which enables the drilling of threaded holes at the inner lining chunk. As the inner lining chunk is used to sustain the destruction by the drilling of the threaded holes and the strain by the insertion of the attachment caps to the spokes, the inner rim surface of the composite material wheel rim is then favorably to be drilled for the threaded holes, where the threaded hole is for the helical joining to the attachment cap of each spoke and for the adjustment of the tightness of the spoke.

### BRIEF DESCRIPTION OF THE DRAWINGS

FIG. 1 is a sectional view of an exemplary embodiment of this invention before a threaded hole is drilled;

FIG. 2 is a sectional view of FIG. 1 viewing from the line 2-2;

FIG. 3 is a sectional view of a right-slanted threaded hole of the exemplary embodiment of this invention;

FIG. 4 is a sectional view of FIG. 3 viewing from the line 4-4;

FIG. 5 is a sectional view of a left-slanted threaded hole of the exemplary embodiment of this invention;

FIG. 6 is a sectional view of FIG. 5 viewing from the line 6-6;

FIG. 7 is an exploded view of a spoke and the composite material wheel rim of the exemplary embodiment of this invention;

FIG. 8 is a joining view (I) of the spoke and the composite material wheel rim of the exemplary embodiment of this invention; and

FIG. 9 is a joining view (II) of the spoke and the composite material wheel rim of the exemplary embodiment of this invention.

### DETAILED DESCRIPTION OF THE INVENTION

To achieve the foregoing objects of the present invention, the techniques adopted and the achievable function are detailed described with reference to the following preferred exemplified embodiments and the accompanying drawings, which would help the honorable Examiner to get a thorough comprehension.

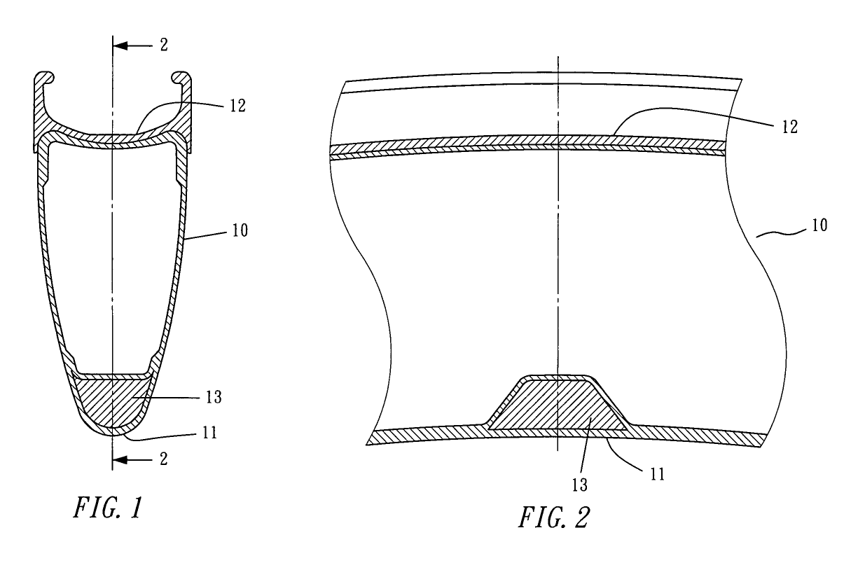

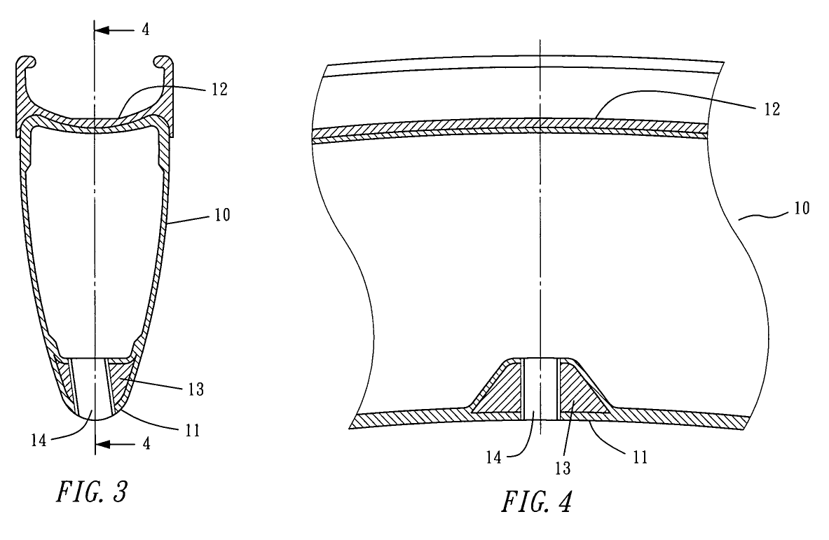

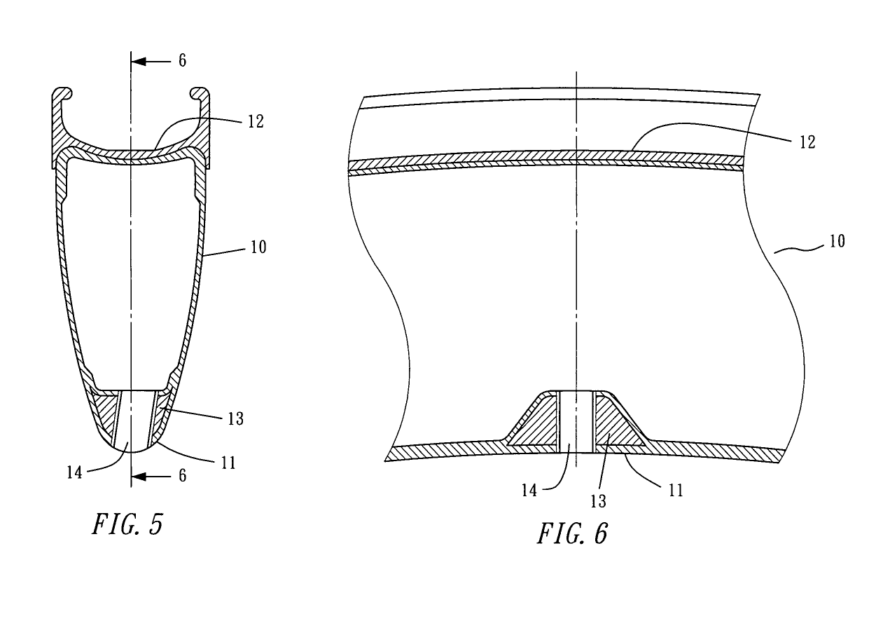

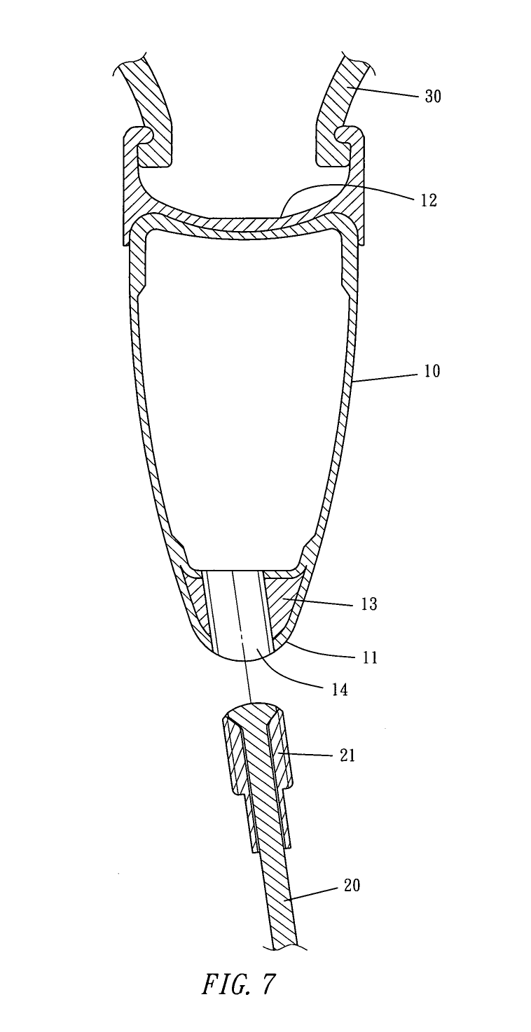

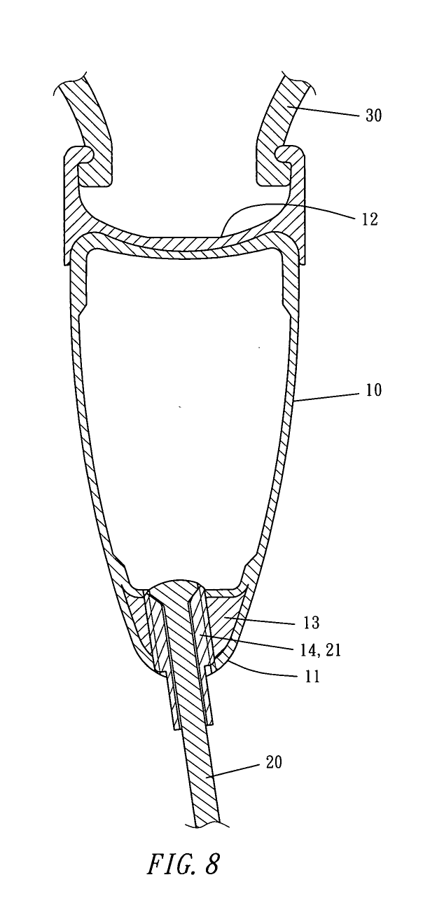

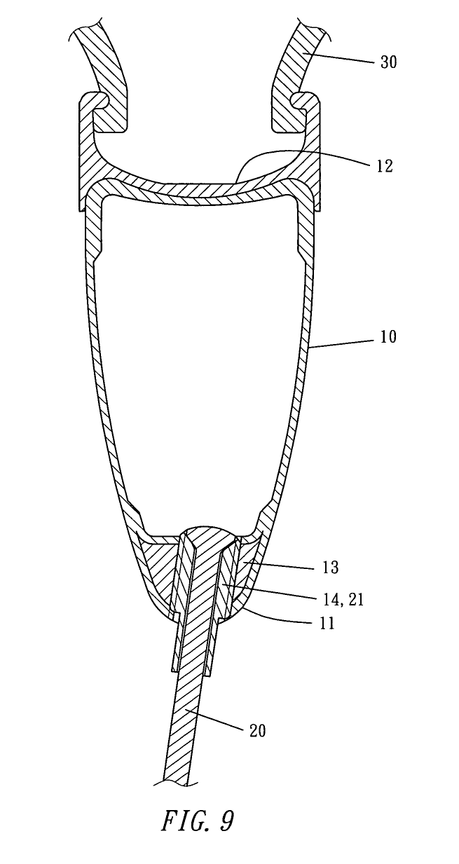

Referring to FIGS. 1 & 2, the composite material wheel rim 10 of the embodiment of this invention is provided with an inner rim surface 11 and an outer rim surface 12. The inner rim surface 11 joins the wheel hub by spokes 20 (shown in FIG. 7), while the outer rim surface 12 is to wear a tire 30. The inner rim surface 11 of the composite material wheel rim 10 links to an attachment cap 21 built at the one end of a spoke 20 to the rim, and a corresponding rigid inner lining chunk 13 (for instance: metallic substance or rigid plastics) is enwrapped by the inner rim surface 11 during the shaping of the composite material wheel rim 10, which enables the drilling of threaded holes 14 at the inner lining chunk 13, and the inner lining chunk 13 is used for the sustaining of the destruction due to the drilling for the threaded holes 14 and of the strain due to the linking of the attachment caps 21 of the spokes 20 (shown in FIGS. 3˜6). The orientation of a threaded hole 14 of the inner rim surface 11 of the composite material wheel rim 10 is coordinately adjusted subject to the alignment of a spoke 20 of the wheel hub as shown in FIGS. 3 & 5. As the attachment cap 21 of a spoke 20 joins the threaded hole 14 of the inner rim surface 11 of the composite material wheel rim 10, shown in FIGS. 7˜9, the attachment cap 21 of a spoke 20 is actually in threaded connection with the threaded hole 14, and the tightness of a spoke 20 is subject to the depth that the attachment cap 21 joined helically to the threaded hole 14.

Accordingly, this invention exploits an inner lining chunk 13 enwrapped by the inner rim surface 11 of the composite material wheel rim 10 for the favorable drilling of the corresponding threaded hole 14 that joins helically to the attachment cap 21 of a spoke 20, which enables a handy drilling for the threaded holes 14 at the inner rim surface 11 of the composite material wheel rim 10, where this invention is therefore construed as creativeness and practicality, which conforms to the requirements of patent application.

What is claimed is:

1. A composite material wheel rim structure, having an inner rim surface and an outer rim surface, where the inner rim surface joins the wheel hub by spokes and the outer rim surface wears a tire, featuring:
the inner rim surface of the composite material wheel rim being linked by an attachment cap of each spoke, and a rigid inner lining chunk being enwrapped by the inner rim surface during the shaping of the composite material wheel rim, which enables the drilling of threaded holes at the inner lining chunk, and the inner lining chunk being used for the sustaining of the destruction due to the drilling for the threaded holes and of the strain due to the link of the attachment caps of the spokes.

2. A composite material wheel rim structure as in claim 1 wherein the inner lining chunk is made of metallic substance.

3. A composite material wheel rim structure as in claim 1 wherein the orientation of a threaded hole is coordinately adjusted subject to the alignment of a spoke.
